(19) United States
(12) Patent Application Publication
(10) Pub. No.: US 2014/0375435 A1
(43) Pub. Date: Dec. 25, 2014

(54) DATA PROCESSING SYSTEM AND METHOD

(71) Applicant: HON HAI PRECISION INDUSTRY CO., LTD., New Taipei (TW)

(72) Inventor: WEI-TE LIN, New Taipei (TW)

(73) Assignee: HON HAI PRECISION INDUSTRY CO., LTD., New Taipei (TW)

(21) Appl. No.: 14/010,543

(22) Filed: Aug. 27, 2013

(30) Foreign Application Priority Data
Jun. 25, 2013 (TW) 102122507

(51) Int. Cl. G08C 19/28

(52) U.S. Cl. CPC G08C 19/28
USPC 340/12.23

(57) ABSTRACT

A data processing system, a data processing method adapted for a number of electronic devices, and a computer-readable storage medium encoded with a computer program are disclosed. The system defines a primary electronic device as a control center to control several auxiliary electronic devices. When one of the several auxiliary electronic devices sends a request to actuate a task, the primary electronic device controls a second auxiliary electronic device to acquire data relative to the request, and controls a third auxiliary electronic device to perform the task based on the acquired data.

### BACKGROUND

1. Technical Field

The disclosure relates to data processing technology and, more particularly, to a data processing system and a data processing method adapted for a number of connected electronic devices.

2. Description of Related Art

Mobile phones become more and more popular, and many people own mobile phones for reasons of portability. However, downloading a large amount of data via the mobile phone, will take a long time, thus it is inconvenient for the user.

Therefore, what is needed is a data processing system to overcome the described shortcoming

### BRIEF DESCRIPTION OF THE DRAWINGS

FIG. 1 is a signal transmission view among a primary electronic device and several auxiliary electronic devices in accordance with an exemplary embodiment.

FIG. 2 is a block diagram of the primary electronic device of FIG. 1.

FIG. 3 is a block diagram of a data processing system applied among the primary electronic device and the several auxiliary electronic devices of FIG. 1.

FIG. 4 is a block diagram of these modules of the data processing system applied among the primary electronic device and the several auxiliary electronic devices of FIG. 3.

FIG. 5 is a flowchart illustrating a method of processing data adapted for the data processing system of FIG. 1.

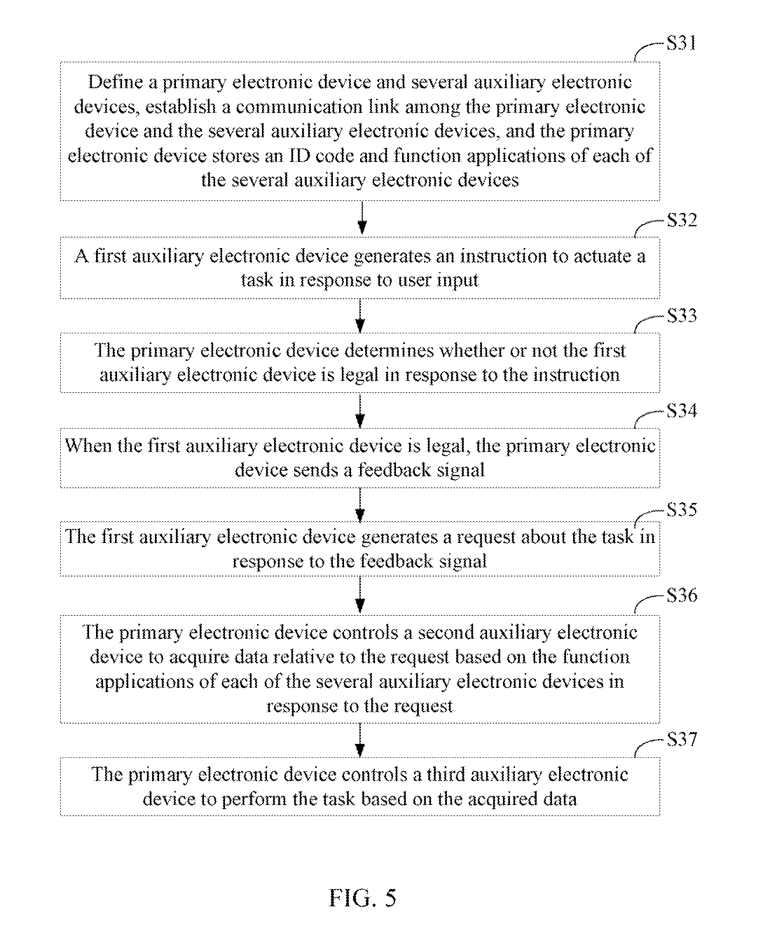

### DETAILED DESCRIPTION

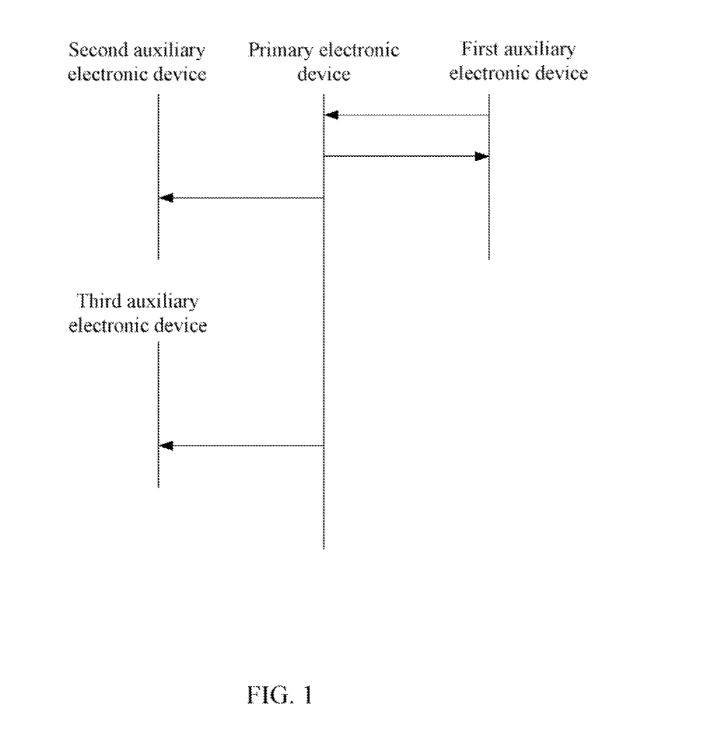

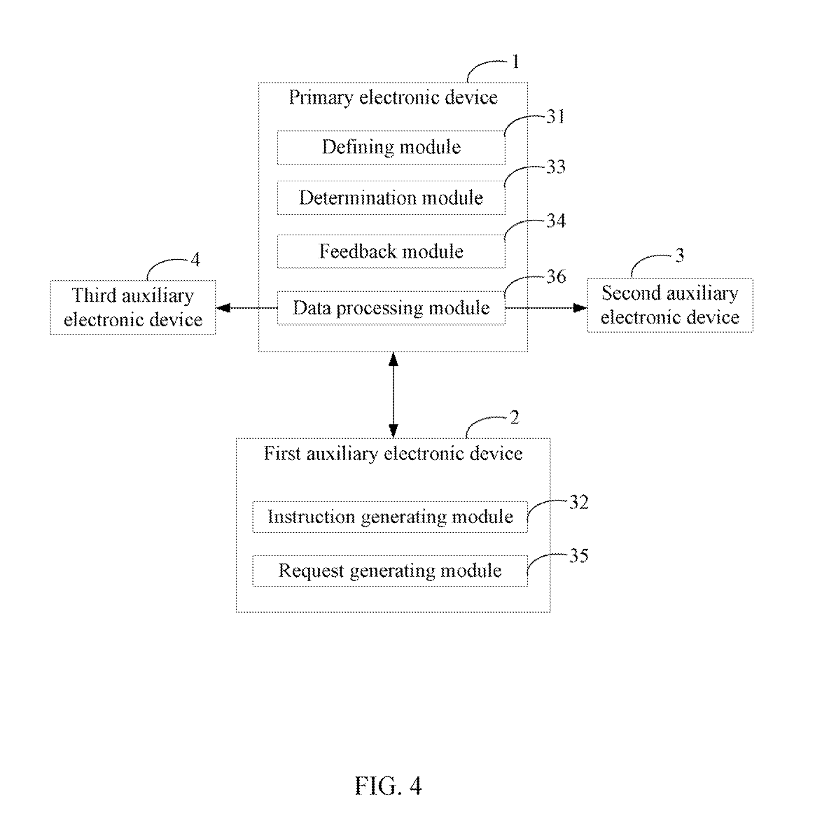

FIG. 1 is a signal transmission view among a primary electronic device and several auxiliary electronic devices in accordance with an exemplary embodiment. A data processing system (shown in FIG. 4) is applied among a number of electronic devices which are connected each other and support a same communication protocol. The number of electronic devices can transmit data to each other and work together. All the electronic devices perform the data processing system.

A primary electronic device is defined among the number of electronic devices and other electronic devices are defined as auxiliary electronic devices. In the embodiment, a first auxiliary electronic device generates an instruction to actuate a task, the primary electronic device controls the second and the third auxiliary electronic devices to work together to finish the task in response to the instruction.

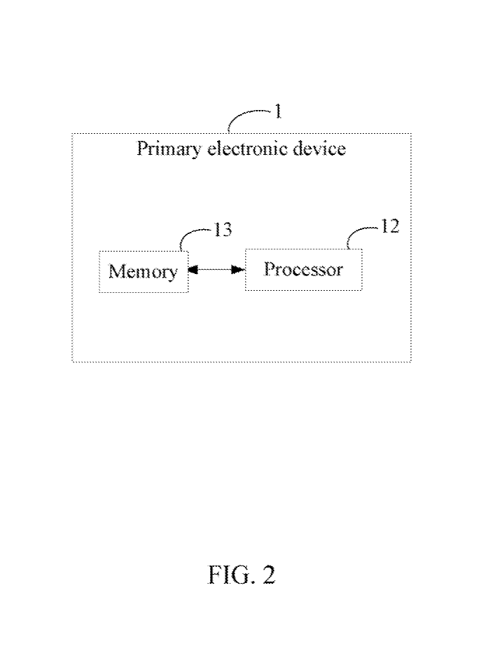

FIG. 2 is a block diagram of the primary electronic device of FIG. 1. The primary electronic device 1 includes a processor 12 and a memory 13. The processor 12 controls the primary electronic device 1 to work. The memory 13 stores data. The primary electronic device 1 may be a computer or a mobile phone. When the primary electronic device 1 is the computer, the primary electronic device 1 is connected to the several auxiliary electronic devices by wire. When the primary electronic device 1 is the mobile phone, the primary electronic device 1 includes a communication unit for sending and receiving wireless signals to/from the several auxiliary electronic devices.

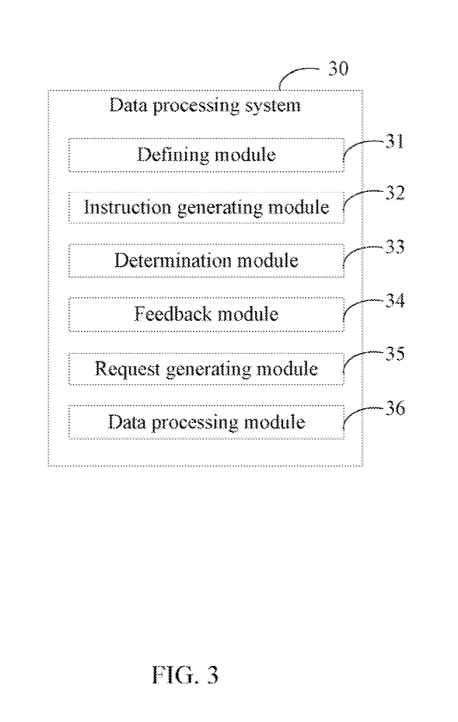

FIGS. 3 and 4 shows that the data processing system 30 further includes a defining module 31, an instruction generating module 32, a determination module 33, a feedback module 34, a request generating module 35, and a data processing module 36, all of which are collection of software instructions and executed by at least one processors 12 from the primary electronic device 1 and one auxiliary electronic devices.

The defining module 31 defines the primary electronic device 1 and the several auxiliary electronic devices, and establishes a communication link among the primary electronic device 1 and the several auxiliary electronic devices based on the same communication protocol. The primary electronic device 1 stores an ID code and function applications of each of the several auxiliary electronic devices, therefore, the primary electronic device 1 can recognize each of the several auxiliary electronic devices according to the ID code. The primary electronic device 1 is utilized to control the several auxiliary electronic devices to work together to finish a task sent by the auxiliary electronic devices. The task may be playing a song or a movie. The defining module 31 is applied in the primary electronic device 1. The primary electronic device 1 may be a server.

For example, the primary electronic device 1 stores an ID code of “A” of a first auxiliary electronic device, an ID code of “B” of a second auxiliary electronic device, and an ID code of “C” of a third auxiliary electronic device. The first auxiliary electronic device is portable, such as a mobile phone. The second auxiliary electronic device is a computer and includes a function application of data processing, such as downloading a large amounts of data from network. The third auxiliary electronic device is a television including a big screen and includes a function application of displaying data.

When the first auxiliary electronic device actuates a task (e.g., playing a song or a movie) while the first auxiliary electronic device does not store data relative to the task, that is, the first auxiliary electronic device does not store the song or movie, the instruction generating module 32 generates an instruction containing the ID code of the first auxiliary electronic device to actuate the task in response to user input to the primary electronic device 1. The instruction generating module 32 is applied in the first auxiliary electronic device. For example, when a user double clicks an icon of a song while the first auxiliary electronic device does not store the song, that is, the instruction generating module 32 generates an instruction containing the ID code of the first auxiliary electronic device to actuate a task of playing a song to the primary electronic device 1.

The determination module 33 applied in the primary electronic device 1 determines whether or not the first auxiliary electronic device is legal in response to the instruction, that is, whether the ID code of the first auxiliary electronic device from the instruction is stored in the primary electronic device 1 or not.

When the first auxiliary electronic device is legal, the feedback module 34 applied in the primary electronic device 1 sends a feedback signal to the first auxiliary electronic device. The request generating module 35 applied in the first auxiliary electronic device generates a request about the task in response to the feedback signal to the primary electronic device 1. The request may include some keywords, such as a song name or a movie name.

The data processing module 36 applied in the primary electronic device 1 controls a second auxiliary electronic device to acquire data relative to the request based on the function applications of each of the several auxiliary electronic devices in response to the request. For example, the second auxiliary electronic device is a computer and has a function application of downloading a large amounts of data from network, and in response to the request, the computer downloads the song from network based on a song name or acquires a stored movie from a memory of the computer based on a movie name. The data processing module 36 further controls a third auxiliary electronic device to perform the task based on the acquired data. For example, the data processing module 36 controls the third auxiliary electronic device, e.g., a television, to play the song or the movie.

Therefore, the data processing system 30 defines the primary electronic device 1 as a control center to control the several auxiliary electronic devices 2. When one of the several auxiliary electronic devices 2 sends a request to actuate a task, the primary electronic device 1 controls a second auxiliary electronic device to acquire data relative to the request, and controls a third auxiliary electronic device to perform the task based on the acquired data.

FIG. 4 is a flowchart illustrating a method of processing data adapted for the data processing system of FIG. 1. In step S31, the defining module 31 defines the primary electronic device 1 and the several auxiliary electronic devices 2, and establishes a communication link among the primary electronic device 1 and the several auxiliary electronic devices 2 based on the same communication protocol, and the primary electronic device 1 stores an ID code and function applications of each of the several auxiliary electronic devices 2.

In step S32, when the first auxiliary electronic device actuates a task while the first auxiliary electronic device does not store data relative to the task, the instruction generating module 32 generates an instruction containing the ID code of the first auxiliary electronic device to actuate the task in response to user input to the primary electronic device 1.

In step S33, the determination module 33 applied in the primary electronic device 1 determines whether or not the first auxiliary electronic device is legal in response to the instruction.

In step S34, when the first auxiliary electronic device is legal, the feedback module 34 applied in the primary electronic device 1 sends a feedback signal to the first auxiliary electronic device. In step S35, the request generating module 35 applied in the first auxiliary electronic device generates a request about the task in response to the feedback signal to the primary electronic device 1.

In step S36, the data processing module 36 applied in the primary electronic device 1 controls a second auxiliary electronic device to acquire data relative to the request based on the function applications of each of the several auxiliary electronic devices in response to the request. In step S37, the data processing module 36 further controls a third auxiliary electronic device to perform the task based on the acquired data.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A data processing system for a plurality of electronic devices, wherein all the plurality of electronic devices support a same communication protocol and transmit data to each other, the data processing system comprising:
one or more processors; and
a plurality of modules to be executed by the one or more processors, the modules comprising:
a defining module to define a primary electronic device and several auxiliary electronic devices among the plurality of electronic devices, wherein the primary electronic device stores function applications of each of the several auxiliary electronic devices;
a request generating module to generate a request about a task when a first auxiliary electronic device actuates the task; and
a data processing module to control a second auxiliary electronic device to acquire data relative to the request based on the function applications of each of the several auxiliary electronic devices in response to the request and control a third auxiliary electronic device to perform the task based on the acquired data.

2. The data processing system of claim 1, further comprising:
an instruction generating module to generate an instruction to actuate task;
a determination module to determine whether or not the first auxiliary electronic device is legal in response to the instruction; and
a feedback module to send a feedback signal to the request generating module when the first auxiliary electronic device is legal.

3. The data processing system of claim 2, wherein the primary electronic device stores an ID code of each of the several auxiliary electronic devices, the instruction contains the ID code of the first auxiliary electronic device, and the determination module is configured to determine whether or not the ID code of the first auxiliary electronic device from the instruction is stored in the primary electronic device.

4. The data processing system of claim 1, wherein the primary electronic device is a server, the first auxiliary electronic device is a mobile phone, the second auxiliary electronic device is a computer, and the third auxiliary electronic device is a television comprising a big screen.

5. The data processing system of claim 4, wherein the mobile phone actuates the task about playing a song or a movie, the server controls the computer to download the song or the movie via network and controls the television to play the song or the movie.

6. The data processing system of claim 4, wherein the mobile phone actuates the task about playing a song or a movie, the server controls the computer to acquire the song or the movie in a memory of the computer and controls the television to play the song or the movie.

7. A data processing method for a plurality of electronic devices, wherein all the plurality of electronic devices support a same communication protocol and transmit data to each other, the method comprising:
defining a primary electronic device and several auxiliary electronic devices among the plurality of electronic devices, wherein the primary electronic device stores function applications of each of the several auxiliary electronic devices;
generating a request about a task when a first auxiliary electronic device actuates the task; and
controlling a second auxiliary electronic device to acquire data relative to the request based on the function applications of each of the several auxiliary electronic devices in response to the request and controlling a third auxiliary electronic device to perform the task based on the acquired data.

8. The data processing method of claim 7, further comprising:
generating an instruction to actuate task;
determining whether or not the first auxiliary electronic device is legal in response to the instruction; and
sending a feedback signal to the request generating module when the first auxiliary electronic device is legal.

9. The data processing method of claim 8, wherein the primary electronic device stores an ID code of each of the several auxiliary electronic devices, the instruction contains the ID code of the first auxiliary electronic device, the method further comprising:
determining whether or not the ID code of the first auxiliary electronic device from the instruction is stored in the primary electronic device.

10. The data processing method of claim 7, wherein the primary electronic device is a server, the first auxiliary electronic device is a mobile phone, the second auxiliary electronic device is a computer, and the third auxiliary electronic device is a television comprising a big screen.

11. The data processing method of claim 10, wherein the mobile phone actuates the task about playing a song or a movie, the server controls the computer to download the song or the movie via network and controls the television to play the song or the movie.

12. The data processing method of claim 10, wherein the mobile phone actuates the task about playing a song or a movie, the server controls the computer to acquire the song or the movie in a memory of the computer and controls the television to play the song or the movie.

13. A computer-readable storage medium encoded with a computer program, the program comprising instructions that when executed by one or more computers cause the one or more computers to perform operations for processing data for a plurality of electronic devices, wherein all the plurality of electronic devices support a same communication protocol and transmit data to each other, the operations comprising:
defining a primary electronic device and several auxiliary electronic devices among the plurality of electronic devices, wherein the primary electronic device stores function applications of each of the several auxiliary electronic devices;
generating a request about a task when a first auxiliary electronic device actuates the task; and
controlling a second auxiliary electronic device to acquire data relative to the request based on the function applications of each of the several auxiliary electronic devices in response to the request and controlling a third auxiliary electronic device to perform the task based on the acquired data.

14. The computer-readable storage medium encoded with a computer program of claim 13, the operations further comprising:
generating an instruction to actuate task;
determining whether or not the first auxiliary electronic device is legal in response to the instruction; and
sending a feedback signal to the request generating module when the first auxiliary electronic device is legal.

15. The computer-readable storage medium encoded with a computer program of claim 14, wherein the primary electronic device stores an ID code of each of the several auxiliary electronic devices, the instruction contains the ID code of the first auxiliary electronic device, the operations further comprising:
determining whether or not the ID code of the first auxiliary electronic device from the instruction is stored in the primary electronic device.

16. The computer-readable storage medium encoded with a computer program of claim 13, wherein the primary electronic device is a server, the first auxiliary electronic device is a mobile phone, the second auxiliary electronic device is a computer, and the third auxiliary electronic device is a television comprising a big screen.

17. The computer-readable storage medium encoded with a computer program of claim 16, wherein the mobile phone actuates the task about playing a song or a movie, the server controls the computer to download the song or the movie via network and controls the television to play the song or the movie.

18. The computer-readable storage medium encoded with a computer program of claim 16, wherein the mobile phone actuates the task about playing a song or a movie, the server controls the computer to acquire the song or the movie in a memory of the computer and controls the television to play the song or the movie.
